(19) United States
(12) Patent Application Publication
(10) Pub. No.: US 2020/0250708 A1
(43) Pub. Date: Aug. 6, 2020

(54) METHOD AND SYSTEM FOR PROVIDING RECOMMENDED DIGITAL CONTENT ITEM TO ELECTRONIC DEVICE

(71) Applicant: YANDEX EUROPE AG, Luzem (CH)

(72) Inventors: Marina Evgenievna SURYGINA, Moscow (RU); Nikita Anatolievich FOMINOV, Moscow (RU); Vitalii Sergeevich KOCHUROV, Moscow (RU); Aleksandr Igorevich KOZHEVNIKOV, Ekaterinburg (RU); Andrey Alekseevich SHESTIMEROV, Moscow (RU); Vasily Valentinovich MIKHAYLOV, Moscow (RU); Pavel Olegovich TYAVIN, Moscow (RU); Mariya Vasilievna FILINA, Moscow (RU)

(21) Appl. No.: 16/739,661

(22) Filed: Jan. 10, 2020

(30) Foreign Application Priority Data
Feb. 6, 2019 (RU) 2019103256

(51) Int. Cl. G06Q 30/02; H04L 29/08; G06F 16/435; G06F 16/9535

(52) U.S. Cl. CPC G06Q 30/0269; H04L 67/306; H04L 67/18; G06Q 30/0275; G06F 16/9535; G06Q 30/0261; G06F 16/435

(57) ABSTRACT

A method and system for providing a digital content item to an electronic device having a display screen with an exposure perimeter. The method comprises receiving a set of data packets indicative of a presence of a group of users located within the exposure perimeter, the group of users comprising one or more users; determining a profile parameter of each of the one or more users of the group of users, the profile parameter being indicative of profile characteristics of the one or more users; executing an impression bid process to determine a digital content item based on the one or more profile parameters of the group of users and the respective set of campaign parameters, the digital content item having a highest resultant bidding value; and transmitting the digital content item to the electronic device for display.

### CROSS-REFERENCE

The present application claims priority to Russian Patent Application No. 2019103256, entitled “METHOD AND SYSTEM FOR PROVIDING RECOMMENDED DIGITAL CONTENT ITEM TO ELECTRONIC DEVICE,” filed on Feb. 6, 2019, the entirety of which is incorporated herein by reference.

### FIELD

The present technology relates to recommendation systems in general and specifically to a method and a system for providing a recommended digital content item to an electronic device.

### BACKGROUND

Various global or local communication networks (the Internet, the World Wide Web, local area networks and the like) offer a user a vast amount of information. The information includes a multitude of contextual topics, such as but not limited to, news and current affairs, maps, company information, financial information and resources, traffic information, games and entertainment-related information. Users use a variety of client devices (desktop, laptop, notebook, smartphone, tablets and the like) to have access to rich content (like images, audio, video, animation, and other multimedia content from such networks).

Whether by navigating on the Internet, or driving on a road, a given user is exposed to a plurality of digital content items. Conventionally, efforts have been focused on providing personalized content items in an online setting, whereas in an offline setting, content items are not personalized. The latter is primarily due to the difficulty of obtaining user information prior to selecting the digital content item.

For example, let us assume that a couple attends a female beauty shop, where the male sits down next to a display screen while waiting for the female to buy her items. While waiting, the male is exposed to a plurality of female beauty related content items, even though these have been originally destined to be exposed to female viewers. Needless to say, exposing content item that is not in the interest of a given user will not only decrease user satisfaction, but also drains computational power beyond necessity.

There is thus a need to provide recommended content item based on the user preference in an offline setting.

United States Patent Application Publication No. 2010/0293058 A1 published on Nov. 18, 2010 to Intertrust Technologies Corp., and titled “Ad Selection Systems and Methods”, teaches systems and methods for dynamically selecting an advertisement for presentation to an end user in combination with an electronic content item. In one embodiment, a control associated with the electronic content item is evaluated to determine whether the advertisement is permitted to be presented in combination with the electronic content item. A control associated with the advertisement is also evaluated to determine an amount that the provider of the advertisement is willing to pay to have the advertisement presented to the end user in combination with the electronic content item. If this amount is greater than the amount bid by other advertisements, then the advertisement and the content item are presented together to the end user

United States Patent Application Publication No. 2008/046924 A1 published Feb. 21, 2008 to Ericsson Television Inc., and titled “System and Methods for Competitive Dynamic Selection of Digital Advertising Assets in a Video Distribution System”, teaches systems and methods for an advertising auctioning capability in conjunction with viewing of a movie or other type of program asset in a video distribution system. At certain points of the movie, called avails, advertisements are presented to the viewer. Each advertisement is selected from a plurality of advertisements based on criteria defined for selection. The selection of the advertisements may be based on criteria defined by the auctioning campaign, by the movie, the advertisements, and demographic information of the viewer selecting the movies. The auctioning process can occur in real-time and in various components, including a video on demand server or the viewer's set-top-box. Various tools are disclosed for indicating the avails, and defining the criteria for conduction the advertising auction campaign

U.S. Pat. No. 8,621,046 B2 issued Dec. 31, 2013 to Intel Corp., and titled “Offline Advertising Services” teaches methods and apparatus for provision of offline advertising services. In one embodiment, content data is stored in a local memory of a computing device prior to going offline. Once offline, the stored content is provided from the local memory, while the metrics regarding the provided content is collected and later transmitted to a remote server. Other embodiments are also described

### SUMMARY

It is an object of the present technology to provide improved method and systems for providing recommended digital content item.

Without wishing to be bound to any specific theory, embodiments of the present technology have been developed based on an assumption that people often carry electronic devices (e.g. mobile phones) that are configured to collect their positions as they travel, as well as be sensed by some sensors. By analyzing the travelled positions, it is possible to predict how likely a user would be exposed to an offline content item.

Moreover, by detecting the electronic devices and correlating the electronic device to a particular user profile, it is further possible to execute an impression bid process to select a digital content item with a highest resultant bidding value that is aligned with the particular user profile.

It is further contemplated that by analyzing the user's movement while displaying the digital content item, it would be possible to make a determination of whether the user has indeed been exposed to the selected digital content item. Moreover, by analyzing movements of other users which may have been exposed to the digital content item but not considered during the impression bid process, it would be possible to execute a post-impression exposure reconciliation process, in which the highest resultant bidding value is altered to properly reflect the users that have been exposed to the digital content item.

In accordance with a first broad aspect of the present technology, there is provided a computer-implemented method for providing a digital content item to an electronic device having a display screen with an exposure perimeter. The method is executed by a server coupled to a content item database hosting a plurality of digital content items, each of the digital content items of the plurality of digital content items being associated with a respective set of campaign parameters indicative of target profile parameters of a target audience. The method comprises: receiving a set of data packets indicative of a presence of a group of users located within the exposure perimeter, the group of users comprising one or more users; determining a profile parameter of each of the one or more users of the group of users, the profile parameter being indicative of profile characteristics of the one or more users; executing an impression bid process to determine a digital content item based on the one or more profile parameters of the group of users and the respective set of campaign parameters, the digital content item having a highest resultant bidding value; and transmitting the digital content item to the electronic device for display.

In some non-limiting embodiments, the set of data packets is a first set of data packets; the group of users is a first group of users; the digital content item is a first digital content item and the method further comprises: receiving a second set of data packets after a predetermined time period following transmission of the first digital content item to the electronic device for display, the second set of data packets being indicative of a second group of users located within the exposure perimeter, the second group of users comprising one or more users; determining the profile parameter of each of the one or more users of the second group of users; executing the impression bid process to determine a second digital content item based on the one or more profile parameters of the group of users and the respective set of campaign parameters, the second digital content item having a highest resultant bidding value; and transmitting the second digital content item to the electronic device for display.

In some non-limiting embodiments, the electronic device comprises a camera configured to capture an image of the exposure perimeter; and the set of data packets comprises a captured image of the one or more users located within the exposure perimeter.

In some non-limiting embodiments, determining a profile parameter to each of the one or more users of the group of users comprises analyzing the captured image of the one or more users.

In some non-limiting embodiments, the server is further coupled to an online user profile database maintaining one or more user profiles of the one or more users; and wherein analyzing the captured image of the one or more users comprises correlating the captured image to the one or more user profiles.

In some non-limiting embodiments, the one or more users is associated with a respective portable electronic device; the electronic device is further coupled to one or more sensors configured to exchange signals with the respective portable electronic device of the one or more users; and wherein the set of data packets further comprises one or more signals of the portable electronic device detected by the sensor, each of the one or more signals comprising at least one of: a signal strength, a period of detection, and a unique identifier.

In some non-limiting embodiments, the set of data packets is a first set of data packets; the captured image is a first captured image; the group of users is a first group of users. The method further comprises: receiving a second set of data packets indicative of a presence of a second group of users located within the exposure perimeter during a time period associated with the display of the digital content item, the second set of data packets comprising at least one of: a second captured image of the one or more users of the second group of users; one or more signals of the portable electronic devices associated with the one or more users of the second group of users; determining the profile parameter to each of the one or more users of the second group of users based on the second set of data packets; determining a profile parameter variation value based on the variations of the profile parameter to each of the one or more users of the first group of users to the profile parameter to each of the one or more users of the second group of users; rectifying the highest bidding value based at least on the profile parameter variation value.

In some non-limiting embodiments, determining the profile parameter to each of the one or more users of the second group of users based on the second set of data packets comprises determining a likelihood parameter indicative of the one or more users having been exposed to the first digital content item based on the one or more signals.

In some non-limiting embodiments, the one or more users of the second group of users correspond to the one or more users of the first group of users; and the first set of data packet comprises a smaller set of information associated with the one or more users, and the second set of data packet comprises a larger set of information associated with the one or more users.

In some non-limiting embodiments, rectifying the highest bidding value comprises one of increasing the highest bidding value and lowering the highest bidding value.

In some non-limiting embodiments, the profile characteristics of a given user include at least one of: an estimated range of age of the given user; a gender of the given user; an estimated time of the given user being located within the exposure perimeter.

In some non-limiting embodiments, the electronic device is a user-independent electronic device.

In some non-limiting embodiments, the user-independent electronic device is located in one of an indoor and an outdoor location.

In some non-limiting embodiments, the electronic device is an outdoor user-independent device; the one or more users is associated with a respective portable electronic device, each of the electronic device having a geo-sensor; and wherein receiving the set of data packets comprises receiving data having been captured by the geo-sensor.

In some non-limiting embodiments, the method further comprises analyzing the data packets to generate a geo-track information associated with the electronic device.

In some non-limiting embodiments, the geo-track information is used for the impression bid process.

In some non-limiting embodiments, the method further comprises using the geo-track information for executing a post-impression exposure reconciliation process.

In accordance with another broad aspect of the present technology, there is provided a system for providing a digital content item to an electronic device having a display screen with an exposure perimeter. The system comprises a server connectable to: a content item database hosting a plurality of digital content items, each of the digital content items of the plurality of digital content items being associated with a respective set of campaign parameters indicative of target profile parameters of a target audience. The server comprises a processor configured to: receive a set of data packets indicative of a presence of a group of users located within the exposure perimeter, the group of users comprising one or more users; determine a profile parameter of each of the one or more users of the group of users, the profile parameter being indicative of profile characteristics of the one or more users; execute an impression bid process to determine a digital content item based on the one or more profile parameters of the group of users and the respective set of campaign parameters, the digital content item having a highest resultant bidding value; and transmit the digital content item to the electronic device for display.

In some non-limiting embodiments, the set of data packets is a first set of data packets; the captured image is a first captured image; the group of users is a first group of users. The processor is further configured to: receive a second set of data packets indicative of a presence of a second group of users located within the exposure perimeter during a time period associated with the display of the digital content item, the second set of data packets comprising at least one of: a second captured image of the one or more users of the second group of users; one or more signals of the portable electronic devices associated with the one or more users of the second group of users; determine the profile parameter to each of the one or more users of the second group of users based on the second set of data packets; determine a profile parameter variation value based on the variations of the profile parameter to each of the one or more users of the first group of users to the profile parameter to each of the one or more users of the second group of users; rectify the highest bidding value based at least on the profile parameter variation value.

In some non-limiting embodiments, to determine the profile parameter to each of the one or more users of the second group of users based on the second set of data packets, the processor is configured to determine a likelihood parameter indicative of the one or more users having been exposed to the first digital content item based on the one or more signals.

In some non-limiting embodiments, the one or more users of the second group of users correspond to the one or more users of the first group of users; and the first set of data packet comprises a smaller set of information associated with the one or more users, and the second set of data packet comprises a larger set of information associated with the one or more users.

In the context of the present specification, a “server” is a computer program that is running on appropriate hardware and is capable of receiving requests (e.g., from client devices) over a network, and carrying out those requests, or causing those requests to be carried out. The hardware may be one physical computer or one physical computer system, but neither is required to be the case with respect to the present technology. In the present context, the use of the expression a “server” is not intended to mean that every task (e.g., received instructions or requests) or any particular task will have been received, carried out, or caused to be carried out, by the same server (i.e., the same software and/or hardware); it is intended to mean that any number of software elements or hardware devices may be involved in receiving/sending, carrying out or causing to be carried out any task or request, or the consequences of any task or request; and all of this software and hardware may be one server or multiple servers, both of which are included within the expression “at least one server”.

In the context of the present specification, “client device” is any computer hardware that is capable of running software appropriate to the relevant task at hand. Thus, some (non-limiting) examples of client devices include personal computers (desktops, laptops, netbooks, etc.), smartphones, and tablets, as well as network equipment such as routers, switches, and gateways. It should be noted that a device acting as a client device in the present context is not precluded from acting as a server to other client devices. The use of the expression “a client device” does not preclude multiple client devices being used in receiving/sending, carrying out or causing to be carried out any task or request, or the consequences of any task or request, or steps of any method described herein.

In the context of the present specification, a “database” is any structured collection of data, irrespective of its particular structure, the database management software, or the computer hardware on which the data is stored, implemented or otherwise rendered available for use. A database may reside on the same hardware as the process that stores or makes use of the information stored in the database or it may reside on separate hardware, such as a dedicated server or plurality of servers.

In the context of the present specification, the expression “information” includes information of any nature or kind whatsoever capable of being stored in a database. Thus information includes, but is not limited to audiovisual works (images, movies, sound records, presentations etc.), data (location data, numerical data, etc.), text (opinions, comments, questions, messages, etc.), documents, spreadsheets, lists of words, etc.

In the context of the present specification, the expression “component” is meant to include software (appropriate to a particular hardware context) that is both necessary and sufficient to achieve the specific function(s) being referenced.

In the context of the present specification, the expression “computer usable information storage medium” is intended to include media of any nature and kind whatsoever, including RAM, ROM, disks (CD-ROMs, DVDs, floppy disks, hard drivers, etc.), USB keys, solid state-drives, tape drives, etc.

In the context of the present specification, the words “first”, “second”, “third”, etc. have been used as adjectives only for the purpose of allowing for distinction between the nouns that they modify from one another, and not for the purpose of describing any particular relationship between those nouns. Thus, for example, it should be understood that, the use of the terms “first server” and “third server” is not intended to imply any particular order, type, chronology, hierarchy or ranking (for example) of/between the server, nor is their use (by itself) intended imply that any “second server” must necessarily exist in any given situation. Further, as is discussed herein in other contexts, reference to a “first” element and a “second” element does not preclude the two elements from being the same actual real-world element. Thus, for example, in some instances, a “first” server and a “second” server may be the same software and/or hardware, in other cases they may be different software and/or hardware.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 depicts a schematic diagram of a system implemented in accordance with non-limiting embodiments of the present technology.

FIG. 2 depicts a schematic illustration of a navigation log associated with an electronic device of the system of FIG. 1.

FIG. 3 depicts a schematic illustration of the digital content item database of the system of FIG. 1.

FIG. 4 depicts a schematic diagram of generating an aggregated user profile.

FIG. 5 depicts a content display device installed in a proximity to a road, this being an example of an outdoor content display device.

FIG. 6 depicts a content display device installed within a building, this being an example of an indoor content display device.

FIG. 7 depicts an example process for selecting a content item.

FIG. 8 depicts a block diagram of a flow chart of a method for providing recommended digital content item.

### DETAILED DESCRIPTION

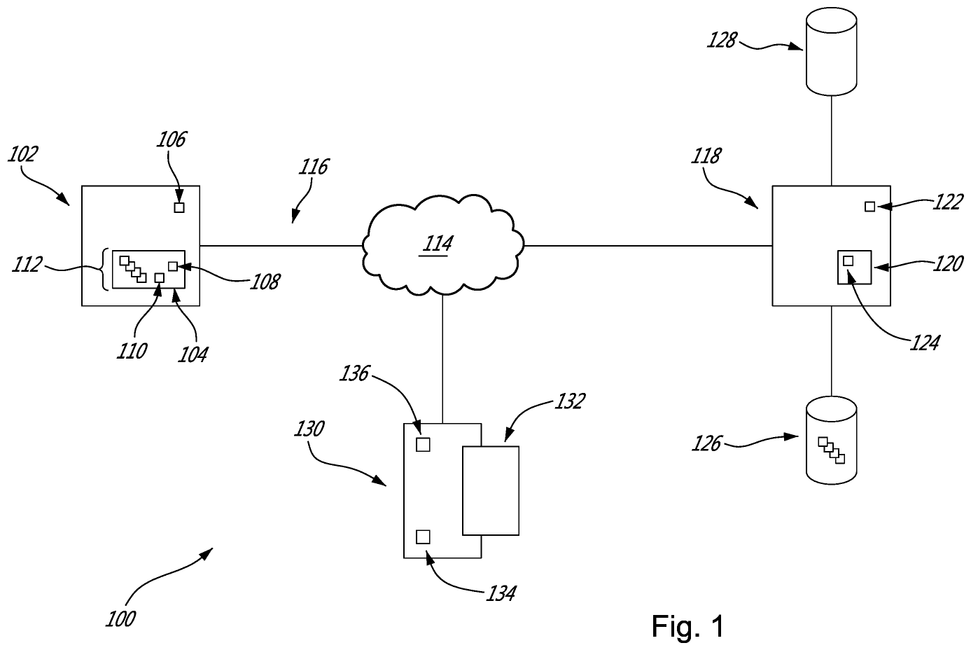

Referring to FIG. 1, there is shown a schematic diagram of a system 100, the system 100 being suitable for implementing non-limiting embodiments of the present technology. It is to be expressly understood that the system 100 is depicted merely as an illustrative implementation of the present technology. Thus, the description thereof that follows is intended to be only a description of illustrative examples of the present technology. This description is not intended to define the scope or set forth the bounds of the present technology. In some cases, what are believed to be helpful examples of modifications to the system 100 may also be set forth below. This is done merely as an aid to understanding, and, again, not to define the scope or set forth the bounds of the present technology. These modifications are not an exhaustive list, and as a person skilled in the art would understand, other modifications are likely possible. Further, where this has not been done (i.e. where no examples of modifications have been set forth), it should not be interpreted that no modifications are possible and/or that what is described is the sole manner of implementing that element of the present technology. As a person skilled in the art would understand, this is likely not the case. In addition, it is to be understood that the system 100 may provide in certain instances simple implementations of the present technology, and that where such is the case they have been presented in this manner as an aid to understanding. As persons skilled in the art would understand, various implementations of the present technology may be of a greater complexity.

The examples and conditional language recited herein are principally intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its spirit and scope. Furthermore, as an aid to understanding, the following description may describe relatively simplified implementations of the present technology. As persons skilled in the art would understand, various implementations of the present technology may be of greater complexity.

Moreover, all statements herein reciting principles, aspects, and implementations of the present technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

The functions of the various elements shown in the figures, including any functional block labelled as a “processor” may be provided through the use of dedicated hardware as well as hardware capable of executing software in association with appropriate software. When provided by a processor, the functions may be provided by a single dedicated processor, by a single shared processor, or by a plurality of individual processors, some of which may be shared. In some non-limiting embodiments of the present technology, the processor may be a general purpose processor, such as a central processing unit (CPU) or a processor dedicated to a specific purpose, such as a graphics processing unit (GPU). Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random access memory (RAM), and non-volatile storage. Other hardware, conventional and/or custom, may also be included.

With these fundamentals in place, we will now consider some non-limiting examples to illustrate various implementations of aspects of the present technology.

The system 100 comprises an electronic device 102. The electronic device 102 is typically associated with a user (not depicted) and, as such, can sometimes be referred to as a “client device”. It should be noted that the fact that the electronic device 102 is associated with the user does not mean to suggest or imply any mode of operation—such as a need to log in, a need to be registered or the like.

In the context of the present specification, unless provided expressly otherwise, “electronic device” is any computer hardware that is capable of running a software appropriate to the relevant task at hand. Thus, some (non-limiting) examples of electronic devices include personal computers (desktops, laptops, netbooks, etc.), smartphones, and tablets. It should be noted that a device acting as an electronic device in the present context is not precluded from acting as a server to other electronic devices. The use of the expression “an electronic device” does not preclude multiple client devices being used in receiving/sending, carrying out or causing to be carried out any task or request, or the consequences of any task or request, or steps of any method described herein.

The electronic device 102 comprises a permanent storage 104. The permanent storage 104 may encompass one or more storage media and generally provides a place to store computer-executable instructions executable by a processor 106. By way of an example, the permanent storage 104 may be implemented as a computer-readable storage medium including Read-Only Memory (ROM), hard disk drives (HDDs), solid-state drives (SSDs), and flash-memory cards.

The electronic device 102 comprises hardware and/or software and/or firmware (or a combination thereof) to execute a navigation application 108. Generally speaking, the purpose of the navigation application 108 is to enable the user to navigate from a given location to another location. The manner in which the navigation application 108 is implemented is known in the art and will not be described herein. Suffice to say that the navigation application 108 may be one of Yandex.Maps™, Yandex.Navigator™, or other commercial or proprietary navigation applications.

Irrespective of how the navigation application 108 is implemented, the navigation application 108 has access to a GPS receiver configured to receive GPS satellite signals and determine the position of the electronic device 102. Generally speaking, the electronic device 102 does not need to be connected to the Internet, nor be executing the navigation application 108, to receive the GPS satellite signals, and as such the electronic device 102 may be configured to track the movement of a user in the form of latitude and longitude irrespective of the availability of the Internet connection.

In some non-limiting embodiments, the electronic device 102 comprises a navigation log 110, which stores the GPS coordinates that have been collected during a time period when the navigation application 108 is active. In some non-limiting embodiments, the navigation log 110 may further host the GPS coordinates that have been collected while the navigation application 108 is not in-use.

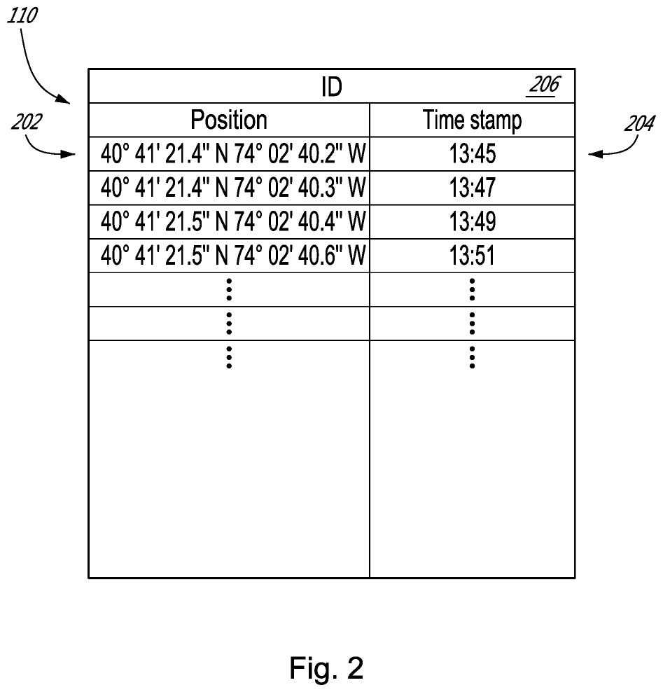

With reference to FIG. 2, a non-limiting embodiment of the navigation log 110 is illustrated. The manner in which the navigation log 110 is populated is not limited. Just as an example, the navigation application 108 may be configured to receive the GPS satellite signals at predetermined time intervals, and convert the GPS satellite signals into GPS coordinates.

The navigation log 110 stores a first GPS coordinate 202 which corresponds to the location of the Statue of Liberty. The first GPS coordinate 202 is associated with a first timestamp 204. The first timestamp 204 corresponds to the time at which the electronic device 102 was at the first GPS coordinate 202.

The navigation log 110 further stores a plurality of GPS coordinates and associated time stamps (not separately numbered). For example, based on the time stamps and GPS coordinates within the navigation log 110, it should be understood that the electronic device 102 has moved 0.5 seconds north and 0.4 seconds west within 6 minutes. Although only four GPS positions are illustrated in the navigation log 110, it should be understood that the navigation log 110 may store more or fewer than four GPS positions.

In some non-limiting embodiments, the navigation application 108 is configured to assign a user device ID 206 to the navigation log 110. For example, the user device ID 206 may correspond to a proprietary ID number assigned by the navigation application 108 as well as other related one or more service applications 112 (described below). In some non-limiting embodiments, the navigation log 110 may further be associated with a user ID (not shown), which may correspond to a user name (such as an email address) associated with the user if the navigation application 108 requires signing-in.

Referring back to FIG. 1, the electronic device 102 comprises hardware and/or software and/or firmware (or a combination thereof) to execute one or more service applications 112. Generally speaking, the one or more service applications 112 correspond to electronic applications accessible by the electronic device 102. In some non-limiting embodiments, the one or more service applications 112 comprise at least one service application (not numbered) that is operated by the same entity that has provided the afore-described navigation application 108. For example, if the navigation application 108 is Yandex.Navigator™, the one or more service applications 112 may include a web browser application Yandex.Browser™, a news application Yandex.News™, a market application Yandex.Market™, and the like. Needless to say, the one or more service applications 112 may also include service applications that are not operated by the same entity that has provided the afore-mentioned navigation application 108, and may comprise for example, social media applications such as Vkontakte™, and music streaming application such as Spotify™.

In some non-limiting embodiments, the activities of the user executed on each of the one or more service applications 112 are collected by one or more associated web server (not shown), and are used to build a profile of the user associated with the electronic device 102. In some non-limiting embodiments, the one or more service applications 112 that are operated by the same entity as the navigation application 108 are configured to store the collected activities with an indication of the user device ID 206.

The electronic device 102 comprises a communication interface (not depicted) for enabling two-way communication with a communication network 114 via a communication link 116. In some non-limiting embodiments of the present technology, the communication network 114 can be implemented as the Internet. In other embodiments of the present technology, the communication network 114 can be implemented differently, such as any wide-area communication network, local area communications network, a private communications network and the like.

How the communication link 116 is implemented is not particularly limited and depends on how the electronic device 102 is implemented. Merely as an example and not as a limitation, in those embodiments of the present technology where the electronic device 102 is implemented as a wireless communication device (such as a smart phone), the communication link 116 can be implemented as a wireless communication link (such as, but not limited to, a 3G communications network link, a 4G communications network link, a Wireless Fidelity, or WiFi®, for short, Bluetooth®, or the like) or wired (such as an Ethernet based connection).

It should be expressly understood that implementations for the electronic device 102, the communication link 116 and the communication network 114 are provided for illustration purposes only. As such, those skilled in the art will easily appreciate other specific implementational details for the electronic device 102, the communication link 116, and the communication network 114. As such, by no means the examples provided hereinabove are meant to limit the scope of the present technology.

The system 100 further includes a server 118 coupled to the communication network 114. The server 118 can be implemented as a computer server. In an example of an embodiment of the present technology, the server 118 can be implemented as a Dell™ PowerEdge™ Server running the Microsoft™ Windows Server™ operating system. Needless to say, the server 118 can be implemented in any other suitable hardware and/or software and/or firmware or a combination thereof. In the depicted non-limiting embodiment of the present technology, the server 118 is a single server. In alternative non-limiting embodiments of the present technology, the functionality of the server 118 may be distributed and may be implemented via multiple servers.

The server 118 comprises a communication interface (not depicted) structured and configured to communicate with various entities (such as the electronic device 102 and other devices potentially coupled to the communication network 114) via the communication network 114. The server 118 comprises a server memory 120 which comprises one or more storage media and generally provides a place to store computer-executable program instructions executable by a server processor 122. By way of example, the server memory 120 may be implemented as a tangible computer-readable storage medium including Read-Only Memory (ROM) and/or Random-Access Memory (RAM). The server memory 120 may also include one or more fixed storage devices in the form of, by way of example, hard disk drives (HDDs), solid-state drives (SSDs), and flash-memory cards.

In some non-limiting embodiments, the server 118 can be operated by the same entity that has provided the afore-described navigation application 108. For example, if the navigation application 108 is a Yandex.Navigator™, the server 118 can be operated by Yandex LLC of Lev Tolstoy Street, No. 16, Moscow, 119021, Russia. In alternative embodiments, the server 118 can be operated by an entity different from the one that has provided the aforementioned navigation application 108.

In accordance with the non-limiting embodiments of the present technology, the server 118 is configured to execute a digital content item selection application 124 (the “selection application 124”). The manner in which the selection application 124 is implemented is described in detail below.

To that end, the server 118 is communicatively coupled to a digital content item database 126. In alternative embodiments, the digital content item database 126 may be communicatively coupled to the server 118 via the communication network 114. Although the digital content item database 126 is illustrated schematically herein as a single entity, it is contemplated that the digital content item database 126 may be configured in a distributed manner.

The digital content item database 126 is populated with a plurality of digital content items (not separately numbered). The nature of each of the plurality of digital content item is not particularly limited. Broadly speaking, a digital content item may correspond to an advertisement, comprising one or more sentences, images, videos, etc.

### Digital Content Item Database 126

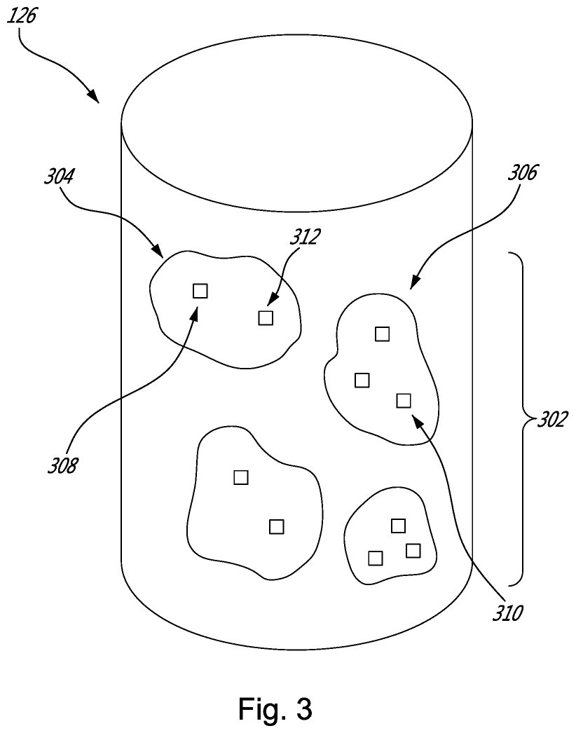

With reference to FIG. 3, a non-limiting embodiment of the digital content item database 126 populated with the plurality of digital content item is illustrated.

The manner in which the digital content item database 126 is populated is not limited. Just as an example the digital content item database 126 may receive the digital content items from one or more advertisers.

The digital content item database 126 stores the plurality of digital content items clustered into one or more topics. As such, the digital content item database 126 is configured to execute a topic clustering routine (not depicted). The manner in which the plurality of digital content items are clustered into one or more topics or events is not limited, and may for example, be done using conventional clustering techniques, such as topic modelling or key words-based approaches.

The plurality of digital content items is clustered into one or more topic clusters 302. For example, the digital content item database 126 stores a first topic cluster 304, a second topic cluster 306, a third topic cluster (not numbered) and a fourth topic cluster (not numbered). The first topic cluster 304 includes a first digital content item 308 and a second digital content item 312, and the second topic cluster 306 includes a third digital content item 310.

In some non-limiting embodiments of the present technology, the digital content item database 126 comprises additional information in respect to each of the plurality of digital content items, such as the duration of the digital content item, target parameters selected by a source of the digital content item, a minimum bidding price for each impression to a user aligned with the target parameters, indication of the digital content item being static or dynamic, and the like.

With continued reference to FIG. 1, the server 118 is further coupled to a user profile database 128 via a dedicated link (not numbered). In alternative non-limiting embodiments of the present technology, the user profile database 128 may be communicatively coupled to the server 118 via the communication network 114. Although the user profile database 128 is illustrated schematically herein as a single entity, it is contemplated that the user profile database 128 may be configured in a distributed manner.

Generally speaking, the user profile database 128 is a repository of one or more user profiles (not illustrated). How the one or more user profiles are implemented is not limited, and may for example be a set of vectors representing the interests of a given user.

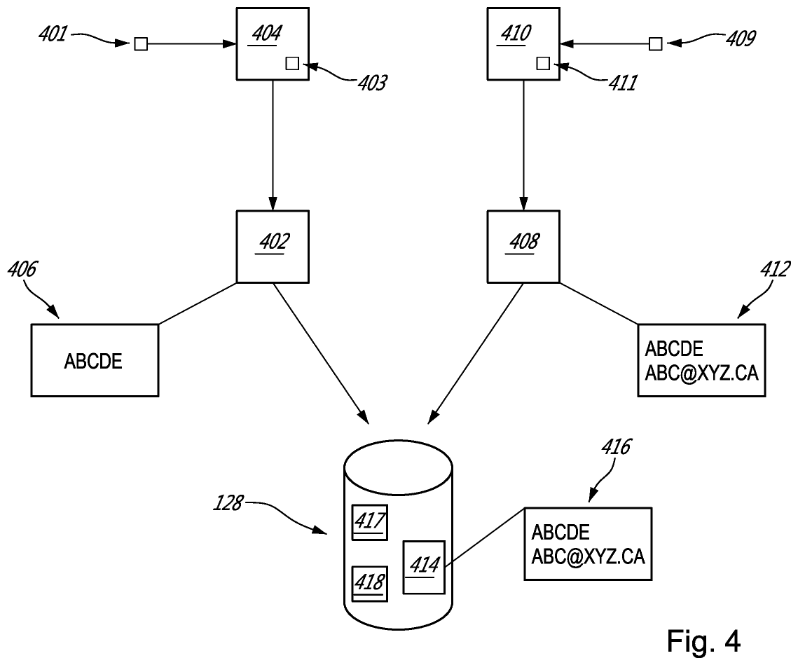

With reference to FIG. 4, a schematic illustration of a process for the aggregation of different user interest profiles associated with the user of the electronic device 102 is depicted.

A first profile 402 is received from a first service server 404. For example, the first service server 404 may be associated with a first service application 401 that corresponds to Yandex.Browser™, which is operated by the same entity providing the aforementioned navigation application 108. The first profile 402 may be generated by the first service server 404 based on browsing log 403 associated with the electronic device 102.

The first profile 402 is associated with a first set of unique IDs 406. For example, the first set of unique IDs 406 may include a proprietary user ID assigned to the electronic device 102 by the first service application 401. Recalling that the first service application 401 is operated by the same entity providing the aforementioned navigation application 108, the first set of unique IDs 406 comprises the user device ID 206 (corresponding to “ABCDE”).

A second profile 408 is received from a second service server 410. For example, the second service server 410 may be associated with a second service application 409 that corresponds to Yandex.Market™, which is operated by the same entity providing the aforementioned navigation application 108. The second profile 408 may be generated by the second service server 410 based on search logs 411 associated with the electronic device 102.

The second profile 408 is also associated with a second set of unique IDs 412. Recalling that the second service application 409 is operated by the same entity providing the aforementioned navigation application, the second set of unique IDs 412 comprises the user device ID 206 (“ABCDE”). Additionally, the second set of unique IDs 412 may also comprise the email address of the user used for sign-in (“ABC@XYZ.CA”). In some non-limiting embodiments, the second profile 408 further comprises a public profile picture (not depicted) of the user associated with the electronic device 102.

In some non-limiting embodiments, if the second service application 409 has been accessed by the same user but on another device than the electronic device 102, the second set of unique IDs 412 further comprises another proprietary device ID (not shown) assigned to the other device.

The user profile database 128 is configured to execute a profile aggregation routine (not depicted). The profile aggregation routine is configured to determine if the first profile 402 and the second profile 408 correspond to the same user. For example, the profile aggregation routine may be configured to determine if the first set of unique IDs 406 corresponds, at least partially, to the second set of unique IDs 412.

If it is determined that the first set of unique IDs 406 corresponds at least partially to the second set of unique IDs 412, the profile aggregation routine is configured to aggregate the first profile 402 and the second profile 408 to generate a first aggregated user profile 414.

As a result of the execution of the profile aggregation routine, the user profile database 128 stores the first aggregated user profile 414 together with a list of associated unique IDs 416 (which comprises the user device ID 206 and the email address), and if present, with the profile picture of the associated user (not depicted).

On the other hand, if the profile aggregation routine determines that the first set of unique IDs 406 does not correspond even partially to the second set of unique IDs 412, the first profile 402 and the second profile 408 are considered to be associated with different users. Consequently the user profile database 128 stores the first profile 402 (and the first set of unique IDs 406) and the second profile 408 (and the second set of unique IDs 412) separately.

Needless to say, although only two user profiles (the first profile 402 and the second profile 408) are illustrated to generate the first aggregated user profile 414, it should be understood that the first aggregated user profile 414 may be generated based on more than two user profiles.

Moreover, although the first aggregated user profile 414 has been generated based solely on service applications that are operated by the same entity, it is not limited as such. Given that the second profile 408 includes the email address associated with the user, it is possible to further aggregate the user's profile with a third profile (not shown) that is received from a different entity, provided that the third profile is also associated with a unique ID that corresponds to the same email address as the one included within the list of associated unique IDs 416.

The user profile database 128 further stores a second aggregated user profile 417 and a third aggregated user profile 418, generated in a similar manner.

With continued reference to FIG. 1, the server 118 is further coupled to a content display device 130. The content display device 130 is configured to receive a digital content item (such as the first digital content item 308) for display by the selection application 124, and as such comprises a display screen 132.

How the content display device 130 is implemented is not limited, and may for example, be implemented as an outdoor advertising structure, such as an electronic billboard placed near a highway or a bus stop, or as an indoor advertising structure, such as an electronic billboard within a metro station or within a store.

Depending on the intended use location, the implementation of the content display device 130 will differ. In those non-limiting embodiments where the content display device 130 is implemented indoor, such as in a mall or a store, the content display device 130 may comprise a sensor 134 and a camera 136.

The sensor 134 is configured to detect wireless signals from one or more electronic devices (e.g. WiFi enabled devices, cellular phones, Bluetooth enabled devices, etc.) when located in the range of the sensor 134, and collect the following data for each detected signal: a Media Access Control (MAC) address(es), signal strength, time of detection and unique identifier (if different than the MAC address). An example of collecting the data for each detected signal is disclosed in U.S. Pat. No. 8,699,370 entitled METHOD AND APPARATUS FOR ANALYSIS OF USER TRAFFIC WITHIN A PREDEFINED AREA issued Apr. 15, 2014, the content of which is incorporated by reference herein in its entirety. Although in the depicted embodiment, only the sensor 134 is present, it is not limited as such, and may include more than one sensor. In some non-limiting embodiments, the sensor 134 is implemented as a router enabling WiFi connection between one or more electronic devices and the communication network 114.

How the camera 136 is implemented is not limited. For example, the camera 136 can include an optical sensor (e.g. a charged coupled device (CCD), or a complementary metal-oxide semiconductor (CMOS) image sensor), to facilitate camera functions, such as recording photographs and video clips. Even though in the depicted embodiment, only the camera 136 is present, in alternative embodiments, more cameras can be implemented.

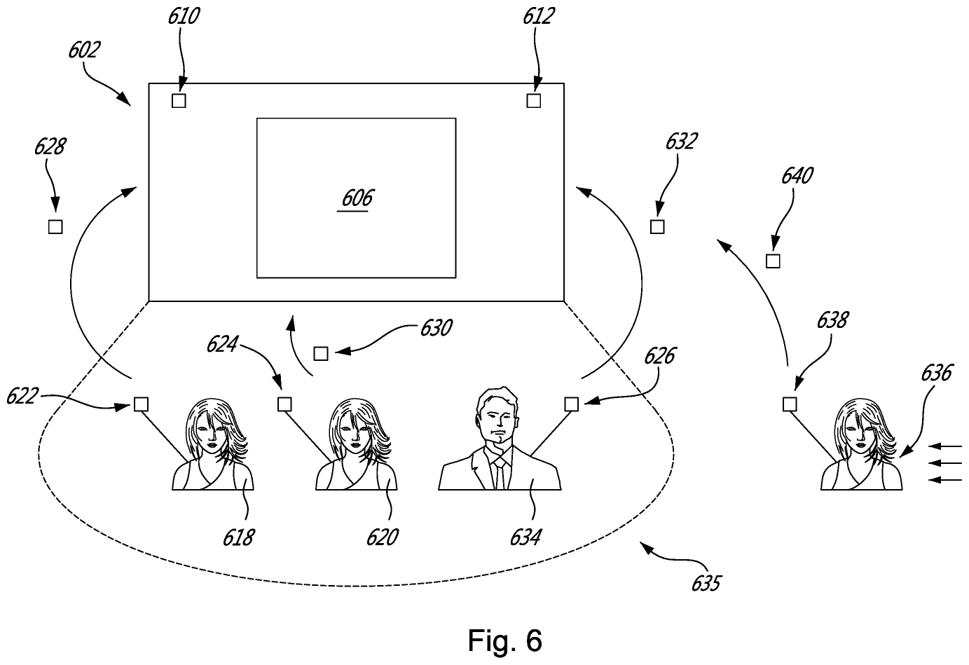

With reference to FIG. 6, a schematic illustration of an indoor electronic display being implemented in accordance with non-limiting embodiments of the present technology is depicted.

As shown, a content display device 602 is installed within a building, such as inside a mall, a shop, and the like. The content display device 602 comprises a display screen 606, a sensor 610 and a camera 612.

The content display device 602 is associated with an exposure perimeter 635. The exposure perimeter 635 may correspond to an area from which the display screen 606 is clearly visible. The manner in which the exposure perimeter 635 is determined is not limited, and may depend on the dimensions of the display screen 606 and may be determined by empirical testing by a human assessor.

Now, in front of the display screen 606, there is a first user 618, a second user 620 and a third user 634. The first user 618 carries a first electronic device 622 (such as a cell phone). The second user 620 carries a second electronic device 624 (such as a cell phone). The third user 634 carries a third electronic device 626 (such as a tablet). Needless to say, it is contemplated that more or fewer users may be in front of the display screen 606, and more or fewer electronic devices may be carried by the first user 618, the second user 620 and the third user 634.

As described above, the sensor 610 is configured to detect the first electronic device 622, the second electronic device 624, and the third electronic device 626. More precisely, the sensor 610 is configured to collect a first identifier 628 associated with the first electronic device 622, a second identifier 630 associated with the second electronic device 624, and a third identifier 632 associated with the third electronic device 626. For example, the first identifier 628 may comprise the unique identifier (such as the MAC address) of the first electronic device 622, the signal strength, and the time of the detection.

In some non-limiting embodiments, the sensor 610 is configured to enable two-way communication with the communication network 114 for the first electronic device 622, the second electronic device 624 and the third electronic device 626. In such non-limiting embodiments, the sensor 610 is further configured to assign an IP address to each of the first electronic device 622, the second electronic device 624 and the third electronic device 626.

The sensor 610 is further configured to periodically detect the signals of the first electronic device 622, the second electronic device 624 and the third electronic device 626.

In some non-limiting embodiments of the present technology, the camera 612 is configured to take a first picture (not depicted) of the exposure perimeter 635, where the first user 618, the second user 620 and the third user 634 are located, in response to the sensor 610 detecting the first electronic device 622, the second electronic device 624 and the third electronic device 626. Needless to say, it is contemplated that in some non-limiting embodiments of the present technology, the camera 612 is configured to take the first picture independently from the detection of the first electronic device 622, the second electronic device 624 and the third electronic device 626 by the sensor 610.

In some non-limiting embodiments of the present technology, the camera 612 is coupled to a movement sensor (not depicted) configured to detect movement within the exposure perimeter 635, and is configured to take the first picture of the exposure perimeter 635 in response to the movement sensor detecting movement within the exposure perimeter 635.

In some non-limiting embodiments of the present technology, the camera 612 is configured to take the first picture in response to a request by the selection application 124. For example, the selection application 124 may request the camera 612 to take the first picture prior to transmitting the digital content item (such as the first digital content item 308) for display, at the beginning of the display of the digital content item, during the display of the digital content item, and right after the display of the digital content item.

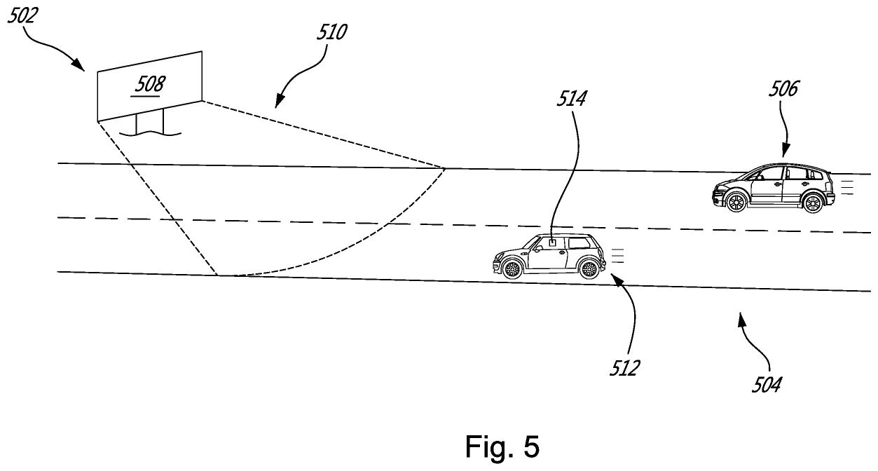

With reference to FIG. 5, a schematic illustration of an outdoor electronic billboard being implemented in accordance with embodiments of the present technology is depicted.

As shown, a content display device 502 is installed in proximity to a road 504 on which a user associated with the electronic device 102 (not shown) driving a first vehicle 506. The content display device 502 comprises a display screen 508, on which the digital content item (such as the first digital content item 308) selected by the selection application 124 is displayed. Also on the road, there is a second vehicle 512 which is driven by a user associated with an electronic device 514.

In some non-limiting embodiments of the present technology, the display screen 508 is associated with an exposure perimeter 510. The exposure perimeter 510 may correspond to the area from which the display screen 508 is clearly visible. The manner in which the exposure perimeter 510 is determined is not limited and may depend on the dimensions of the display screen 508, and/or the presence of obstacles (such as buildings) nearby, and may be determined by empirical testing by a human assessor.

### Selection Application 124

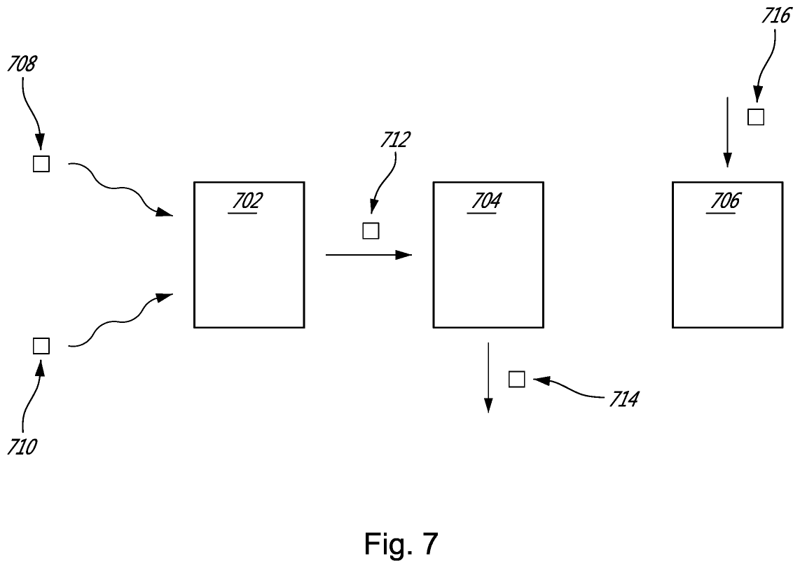

With reference to FIG. 7, there is provided a schematic illustration of the selection application 124 being implemented in accordance with non-limiting embodiments of the present technology. The selection application 124 executes (or otherwise has access to): a receiving routine 702, a bid-determination routine 704, and a post-bid management routine 706.

In the context of the present specification, the term “routine” refers to a subset of the computer executable program instructions of the selection application 124 that is executable by the server processor 122 to perform the functions explained below in association with the various routines (the receiving routine 702, the bid-determination routine 704, and the post-bid management routine 706). For the avoidance of any doubt, it should be expressly understood that the receiving routine 702, the bid-determination routine 704, and the post-bid management routine 706 are illustrated schematically herein as separate entities for ease of explanation of the processes executed by the selection application 124. It is contemplated that some or all of the receiving routine 702, the bid-determination routine 704, and the post-bid management routine 706 may be implemented as one or more combined routines.

For ease of understanding the present technology, functionality of each one of the receiving routine 702, the bid-determination routine 704, and the post-bid management routine 706, as well as data and/or information processed or stored therein are described below.

Furthermore, for ease of understanding of the current technology, the functionality of each one of the receiving routine 702, the bid-determination routine 704, and the post-bid management routine 706, as well as data and/or information processed or stored therein will be explained below with reference to a first scenario in reference to FIG. 5, and a second scenario in reference to FIG. 6. It should be understood that the scenarios presented herein below is for ease of understanding only, and the present technology is in no way to be limited based on the scenario presented below.

### Receiving Routine 702—Scenario 1

The receiving routine 702 is configured to receive a data packet 708 from one or more electronic devices. For example, the data packet 708 comprises the navigation log for each of the one or more electronic devices nearby the content display device 502. In some non-limiting embodiments, the navigation application 108 pre-stores the location of the content display device 502, and is configured to transmit the navigation log 110 to the receiving routine 702 in response to arriving at a predetermined distance from the content display device 502. How the predetermined distance is determined is not limited, and may for example, be 100 meters, 200 meters from the location of the content display device 502, and so on.

As discussed briefly above with reference to FIG. 2, the navigation log 110 may store the user device ID 206 and a list of GPS positions with respective time stamps that have been collected offline, and/or during use of the navigation application 108.

In the present scenario, the navigation log 110 stores the GPS positions that are collected during the in-use phase of the navigation application 108. Needless to say, the navigation log 110 may also be stored within a server (not depicted) associated with the navigation application 108, in which case the data packet 708 is received from the server.

Let us assume that the data packet 708 comprises the navigation logs received from the electronic device 102 (i.e. the navigation log 110), and the electronic device 514, both determined to be within the predetermined distance. Needless to say, it is contemplated that more or less electronic devices be within the predetermined distance.

The receiving routine 702 is then configured to build a user navigation status associated with each of the electronic device 102 and the electronic device 514, which is indicative of the respective real-time user movement. For example, based on the navigation log 110, the user navigation status may be indicative that the user associated with the electronic device 102 is travelling on the road 504 towards the content display device 502.

In some non-limiting embodiments of the present technology, the receiving routine 702 is further configured to receive a data packet 710 from the content display device 502. The data packet 710 comprises an indication of the exposure perimeter 510 associated with the content display device 502. Needless to say, it is contemplated that the exposure perimeter 510 can be stored within the server 118 instead.

Based on the exposure perimeter 510 and the user navigation status associated with the electronic device 102 and the electronic device 514, the receiving routine 702 is configured to determine whether the electronic device 102 and/or the electronic device 514 is within the exposure perimeter 510 or, is configured to determine an entry likelihood parameter indicative of the electronic device 102 and/or the electronic device 514 entering the exposure perimeter 510 within a predetermined period of time. For example, the receiving routine 702 may be configured to apply a set of heuristic rules to determine the entry likelihood parameter. Just as a non-limiting example, the set of heuristic rules may include one or more of the following determinations to determine the entry likelihood parameter of the electronic device 102:
The velocity at which the electronic device 102 is travelling;
The distance of the electronic device 102 to the exposure perimeter 510; and
The presence of one or more intersections between the electronic device 102 and the exposure perimeter 510.

How the entry likelihood parameter is implemented is not limited, and may for example be implemented as a percentage value, a range value (i.e. from 1 to 100), or as a binary value.

The receiving routine 702 is further configured to compare the entry likelihood parameter against a threshold value. The manner in which the threshold value is determined is not limited, and may for example be determined empirically. Furthermore, how the threshold value is implemented is not limited, and will depend on how the entry likelihood parameter is implemented.

### Bid-Determination Routine 704—Scenario 1

In response to the determination that the electronic device 102 and the electronic device 514 are within the exposure perimeter 510 or the respective entry likelihood parameters being above the threshold value, the receiving routine 702 is configured to transmit a data packet 712 to the bid-determination routine 704. The data packet 712 comprises an indication of the user device ID 206 associated with the electronic device 102 (which is retrieved from the navigation log 110 received by the receiving routine 702) and the a user device ID (not shown) associated with the electronic device 514 (which is also retrieved from the navigation log (not shown) received by the receiving routine 702).

The bid-determination routine 704 is configured to execute the following functions. First the bid-determination routine 704 is configured to access the user profile database 128 and retrieve the respective aggregated user profile based on the user device IDs included within the data packet 712.

Let us assume for example, that it is determined that the first aggregated user profile 414 is associated with the electronic device 102, and the second aggregated user profile 417 is associated with the electronic device 514.

Once the first aggregated user profile 414 and the second aggregated user profile 417 have been retrieved, the bid-determination routine 704 is configured to execute an impression bid process based on the first aggregated user profile 414 and the second aggregated user profile 417. More particularly, the bid-determination routine 704 is configured to access the digital content item database 126 and determine which of the one or more content items is to be displayed on the content display device 502 via the impression bid process.

How the impression bid process is implemented is not limited and may for example be a real-time bidding process. Suffice to say that based on the first aggregated user profile 414 and the target parameters associated with each content item, the bid-determination routine 704 is configured to determine a digital content item having a highest resultant bidding value.

For example, let us assume that the user associated with the electronic device 102 is a female in her mid-twenties, and the user associated with the electronic device 514 is a female in her late fifties. Based on this information, the bid-determination routine 704 is configured to execute the impression bid process (such as a real-time bidding process), in which the bid-determination routine 704 is configured to determine a highest digital content item having a highest resultant bidding value based on the target parameters associated with each content item.

Let us assume, for the purpose of the example, that the highest resultant bidding value corresponds to the first digital content item 308 which bided 2 cents for each female over the age of 20 (thus having a highest resultant bidding value of 4 cents).

As a result, the bid-determination routine 704 is configured to transmit a data packet 714 to the content display device 502. The data packet 714 comprises the first digital content item 308 to be displayed on the display screen 508.

In some non-limiting embodiments, the digital content item 308 is static (or unchanging). In some non-limiting embodiments, the digital content item 308 is dynamic, such as a video. Depending on whether the digital content item 308 is static or dynamic, the data packet 714 further comprises display instructions, such as the duration and time at which the digital content item 308 must be displayed.

### Post-Bid Management Routine 706—Scenario 1

After the digital content item 308 has been displayed at least once by the display screen 508, the post-bid management routine 706 is configured to receive a data packet 716 from the electronic device 102 and the electronic device 514. The data packet 716 comprises updated navigation logs (not shown). More precisely, the updated navigation logs comprises additional GPS positions (and their respective time stamps) that has been collected, by the respective electronic device 102 and electronic device 514, since the data packet 708 has been transmitted to the receiving routine 702.

Based on the updated navigation logs, the post-bid management routine 706 is configured to update the respective user status. The updated user navigation status are indicative of the users' (users associated with the electronic device 102 and electronic device 514) trajectory between the time period from (i) before the display of the digital content item 308 until (ii) the end of the displaying of the digital content item 308, by the display screen 508.

For each of the updated user navigation status, the post-bid management routine 706 is configured to determine if the updated user navigation history is indicative of the user being exposed to the first digital content item 308. For example, the post-bid management routine 706 is configured to determine if any of the navigated positions (based on the updated user navigation history) correlate with the exposure perimeter 510 during the relevant time (i.e. duration of the first digital content item 308) and for a pre-determined minimum amount of time (to be considered to have been exposed). For example, if the first digital content item 308 is static, the pre-determined minimum amount of time may be 1 second. On the other hand, if the first digital content item 308 is dynamic, the pre-determined minimum amount of time may correspond to the duration of the first digital content item 308.

In some non-limiting embodiments of the present technology, the post-bid management routine 706 is configured to apply a set of heuristic rules to determine a likelihood parameter that is indicative of the user having been exposed to the first digital content item 308. Just as a non-limiting example, the set of heuristic rules may include one or more of the following determinations for the updated user navigation history associated with the electronic device 102:
The pre-determined minimum amount of time;
Whether the user has been in the exposure perimeter 510;
Whether at the time the user has been in the exposure perimeter 510, the first digital content item 308 was being displayed by the content display device 502;
The dwelling time of the user in the exposure perimeter 510; and
The velocity of the user when passing through the exposure perimeter 510.

How the likelihood parameter is implemented is not limited, and may for example be implemented as a percentage value, a range value (i.e. from 1 to 100), or as a binary value.

The post-bid management routine 706 is further configured to compare the likelihood parameter against a threshold value. The manner in which the threshold value is determined is not limited, and may for example be determined empirically. Furthermore, how the threshold value is implemented is not limited, and will depend on how the likelihood parameter is implemented.

Now, if it is determined that the likelihood parameter associated with either one of the electronic device 102 or the electronic device 514 is below the threshold value (i.e. the user was not exposed to the first digital content item 308), the post-bid management routine 706 is configured to execute a post-impression reconciliation process. More precisely, since the first digital content item 308 has not been exposed to a user that it was supposed to be exposed to, the post-bid management routine 706 is configured to alter, or change the outcome of the bidding process executed by the bid-determination routine 704.

Indeed, recalling that the first digital content item 308 is associated with a bid of 2 cents for each female over the age of twenty (for a total of 4 cents), the post-bid management routine 706 is configured to decrease the total bidding value of the first digital content item 308 to a total of 2 cents, since only one of the users associated with the electronic device 102 and the electronic device 514 has been exposed to the first digital content item 308. Needless to say, if for example, both users of the electronic device 102 and the electronic device 514 have the likelihood parameters below the threshold value, the total bidding value of the first digital content item 308 is decrease to 0 cents.

If, on the other hand, it is determined that both likelihood parameters are above the threshold value (i.e., the users were exposed to the first digital content item 308), the post-bid management routine 706 does not alter, or change, the bidding value of the first digital content item 308, and therefore the highest resultant bidding value determined by the bid-determination routine 704 remains unchanged.

Now, although the above explained post-impression reconciliation process has been explained with reference to the electronic device 102 and the electronic device 514 from the beginning to the end of the displaying of the first digital content item 308, it is not limited as such. Indeed, it is contemplated that during the displaying of the first digital content item 308, another electronic device (not depicted) passes through the exposure perimeter 510. As such, in some non-limiting embodiments of the present technology, the data packet 716 may further comprise the navigation log (not depicted) associated with the other electronic device (not depicted). The post-bid management routine 706 is then configured to determine the user aggregated profile and the likelihood parameter as described above. If, for example, it is determined that the user aggregated profile matches the target parameters of the first digital content item 308, the highest resultant bidding value is increased by 2 cents.

Turning now to FIG. 6, the functionality of each one of the receiving routine 702, the bid-determination routine 704, and the post-bid management routine 706, as well as data and/or information processed or stored therein will be explained below with reference to the second scenario in reference to FIG. 6.

For simplicity, elements or functions of the Scenario 2 have been labelled with the same reference numerals. New elements or functions not disclosed within the Scenario 1 have been labelled with additional reference numerals. It should be understood that some elements or functions performed under Scenario 1 is not similarly performed in Scenario 2 and vice-versa.

### Receiving Routine 702—Scenario 2

The receiving routine 702 is configured to receive a data packet 708 from one or more electronic devices. For example, the data packet 708 comprises the navigation log for each of the one or more electronic devices nearby the content display device 602. In some non-limiting embodiments, the navigation application 108 pre-stores the location of the content display device 602, and is configured to transmit the navigation log 110 to the receiving routine 702 in response to arriving at a predetermined distance from the content display device 502. How the predetermined distance is determined is not limited, and may for example be 10 meters, 20 meters from the location of the content display device 502, and so on.

As discussed briefly above with reference to FIG. 2, the navigation log 110 may store the user device ID 206 and a list of GPS positions with respective time stamps that have been collected offline, and/or during use of the navigation application 108.

In the present scenario, the navigation log 110 stores the GPS positions that are collected during the in-use phase of the navigation application 108. Needless to say, the navigation log 110 may also be stored within a server (not depicted) associated with the navigation application 108, in which case the data packet 708 is received from the server.

Let us assume that the data packet 708 comprises the navigation logs received from the first electronic device 622, the second electronic device 624 and the third electronic device 626, all determined to be near the content display device 602. Needless to say, it is contemplated that more or less electronic devices be within the predetermined distance.

The receiving routine 702 is then configured to build a user navigation status associated with each of the first electronic device 622, the second electronic device 624 and the third electronic device 626, which is indicative of the respective real-time user movement.

In some non-limiting embodiments of the present technology, the receiving routine 702 is further configured to augment the user navigation history. Developers have appreciated that although the user navigation history may be able to provide a good indication of where the respective user is travelling, in some situations, such as inside a building, it may not be sufficiently precise to determine the actual location of the a given user. For example, it may be that the building comprises more than two floors, which would make the determination of the current floor location difficult if only the user navigation history is used.

How the user navigation history is augmented is not limited, and may for example, be executed in response to the first electronic device 622, the second electronic device 624 and the third electronic device 626 establishing a connection to the communication network 114 via the sensor 610.

More precisely, based on the information that a connection has been established between the first electronic device 622, the second electronic device 624 and the third electronic device 626 and the sensor 610, the receiving routine 702 is further configured to update the current location associated with each of the first electronic device 622, the second electronic device 624 and the third electronic device 626 based on the associated signal strengths.

Indeed, as briefly mentioned above the sensor 610 is configured to assign a unique IP address to each of the first electronic device 622, the second electronic device 624 and the third electronic device 626 once a connection is established. As such, in some non-limiting embodiments of the present technology, the data packet 708 further comprises an indication of the IP address assigned by the sensor 610 to the first electronic device 622, the second electronic device 624 and the third electronic device 626.

In some non-limiting embodiments, the navigation application 108 of each of the first electronic device 622, the second electronic device 624 and the third electronic device 626 is configured to transmit the unique IP address to the receiving routine 702 together with their respective user device ID.

As such, the receiving routine 702 is configured to augment the user navigation history by correlating the signal strengths collected by the sensor 610 and the GPS positions of the first electronic device 622, the second electronic device 624 and the third electronic device 626.

In some non-limiting embodiments, the receiving routine 702 is configured to determine whether or not the users are within the exposure perimeter 635, based on the augmented navigation history. For example, if the associated signal strength is above a predetermined threshold, it is determined that the associated electronic device is within the exposure perimeter 635.

In some non-limiting embodiments of the present technology, if no connection is established with the sensor 610, the user navigation history is not augmented.

In some non-limiting embodiments, the receiving routine 702 is further configured to receive a data packet 710. The data packet 710 comprises collected identifiers associated with the electronic devices (e.g. the first identifier 628, the second identifier 630 and the third identifier 632) if, no connection is established with the sensor 610.

In some non-limiting embodiments, the data packet 710 further comprises a first captured image of the exposure perimeter 635. For example, the first captured image may comprise a face of the first user 618, the face of the second user 620 and the face of the third user 634.

In other words, the data packet 710 may include one or more different types of user-associated information that may enable the receiving routine 702 to acquire additional information about the existing users being exposed to the targeted message or new users being exposed to the targeted message.

### Bid-Determination Routine 704—Scenario 2

The receiving routine 702 is configured to transmit a data packet 712 to the bid-determination routine 704. The data packet 712 comprises the information contained within the data packet 708 and data packet 710.

Let us assume, for the purpose of explanation, that the first user 618, the second user 620 and the third user 634 are determined to be within the exposure perimeter 635, either because their associated devices (the first electronic device 622, the second electronic device 624 ad the third electronic device 626) are connected with the sensor 610 and have signals above the predetermined strength, or because the their faces are captured by the first captured image.

Now, based on the data packet 712, the bid-determination routine 704 is configured to (i) determine user profiles associated with each of the first user 618, the second user 620 and the third user 634, and (ii) associate the first electronic device 622, the second electronic device 624 and the third electronic device 626 with their respective users (i.e. the first user 618, the second user 620 and the third user 634).

In some non-limiting embodiments, the bid-determination routine 704 is configured to access the user profile database 128 and determine, based on the user device IDs contained within the navigation logs, that the first user 618 is associated with the first aggregated user profile 414, the second user 620 is associated with the second aggregated user profile 417, and the third user 634 is associated with the third aggregated user profile 418.

Moreover, recalling that the respective navigation application 108 of the electronic devices has previously transmitted the unique IP address and the user device ID, the bid-determination routine 704 is further configured to determine that the first electronic device 622 is associated with the first user 618, the second electronic device 624 is associated with the second user 620, and the third electronic device 626 is associated with the third user 634.

In some non-limiting embodiments, the bid-determination routine 704 is configured to execute a face recognition application (not shown). The face recognition application is configured to access the user profile database 128, and determine if each of the faces of the first user 618, second user 620 and third user 634 is associated with a user profile (i.e. the first aggregated user profile 414, the second aggregated user profile 417 and the third aggregated user profile 418). How the face recognition application is implemented is generally known in the art, and will not be described herein.

Moreover, the bid-determination routine 704 is further configured to associate each of the first user 618, the second user 620 and the third user 634 with a respective electronic device based on the first captured image, as disclosed in a co-owned U.S. patent application attorney docket number 40703-128 entitled METHOD AND SYSTEM FOR PROVIDING A RECOMMENDED DIGITAL CONTENT ITEM, the content of which is incorporated by reference herein in its entirety.

Based on the determined aggregated user profiles, the bid-determination routine 704 is configured to execute an impression bid process. More particularly, the bid-determination routine 704 is configured to access the digital content item database 126 and determine which of the one or more content items is to be displayed on the content display device 602 via the impression bid process.

For example, let us assume that based on their respective aggregated user profiles, the first user 618 is determined to be a female in her mid-twenties, the second user 620 is determined to be a female in her fifties and the third user 634 is determined to be a male in his thirties. Based on this information, the bid-determination routine 704 is configured to execute the impression bid process (such as a real-time bidding process), in which the bid-determination routine 704 is configured to determine a highest digital content item having a highest resultant bidding value based on the target parameters associated with each content item.

Let us assume, for the purpose of the example that the highest resultant bidding value corresponds to the first digital content item 308, which bided 2 cents for each female over the age of 20 (thus having a highest resultant bidding value of 4 cents).

As a result, the bid-determination routine 704 is configured to transmit a data packet 714 to the content display device 602. The data packet 714 comprises the first digital content item 308 to be displayed on the display screen 606.

In some non-limiting embodiments, the digital content item 308 is static (or unchanging). In some non-limiting embodiments, the digital content item 308 is dynamic, such as interactive or a video. Depending on whether the digital content item 308 is static or dynamic, the data packet 714 further comprises display instructions, such as the duration and time at which the digital content item 308 must be displayed.

### Post-Bid Management Routine 706—Scenario 2

After the digital content item 308 has been displayed at least one by the display screen 606, the post-bid management routine 706 is configured to receive a data packet 716 from the first electronic device 622, the second electronic device 624 and the third electronic device 626. The data packet 716 comprises updated navigation logs (not shown). More precisely, the updated navigation logs comprises additional GPS positions (and their respective time stamps) that have been collected, by the respective first electronic device 622, the second electronic device 624 and the third electronic device 626, since the data packet 708 has been transmitted to the receiving routine 702.

In some non-limiting embodiments, the data packet 716 further comprises the signal strengths of the first identifier 628, the second identifier 630 and the third identifier 632 as well as the signal strengths of the connection (if a connection is established between with the sensor 610) collected during the displaying of the first digital content item 308.

Now, based on the updated navigation logs, the post-bid management routine 706 is configured to determine a user trajectory for the first user 618, the second user 620 and the third user 634 between the time period from (i) before the display of the digital content item 308 until (ii) the end of the displaying of the digital content item 308, by the display screen 606.

For each of the electronic devices (the first electronic device 622, the second electronic device 624 and the third electronic device 626), the post-bid management routine 706 is configured to determine if the user trajectory is indicative of the user being exposed to the first digital content item 308. For example, the post-bid management routine 706 is configured to determine if any of the navigated positions correlate with the exposure perimeter 510 during the relevant time (i.e. duration of the first digital content item 308) and for a pre-determined minimum amount of time (to be considered to have been exposed). For example, if the first digital content item 308 is static, the pre-determined minimum amount of time may be 1 second. On the other hand, if the first digital content item 308 is dynamic, the pre-determined minimum amount of time may correspond to the duration of the first digital content item 308.

In some non-limiting embodiments of the present technology, the post-bid management routine 706 is configured to apply a set of heuristic rules to determine the likelihood parameter to determine a likelihood parameter that is indicative of the user having been exposed to the first digital content item 308. Just as a non-limiting example, the set of heuristic rules may include one or more of the following determinations:
The pre-determined minimum amount of time;
Whether the collected signal strengths are indicative of the first user 618, the second user 620 and the third user 634 being close to the content display device 602;
Whether one or more signals associated with the first electronic device 622, the second electronic device 624 and the third electronic device 626 have been lost;
Whether the first capture image is indicative of the first user 618, the second user 620 and the third user 634 looking at the display screen 606;
Whether the collected signal strengths are indicative of the first user 618, the second user 620 and the third user 634 being constant.

How the likelihood parameter is implemented is not limited, and may for example be implemented as a percentage value, a range value (i.e. from 1 to 100), or as a binary value.

The post-bid management routine 706 is further configured to compare the likelihood parameter against a threshold value. The manner in which the threshold value is determined is not limited, and may for example be determined empirically. Furthermore, how the threshold value is implemented is not limited, and will depend on how the likelihood parameter is implemented.

Now, if it is determined that the likelihood parameter of one of the users is below the threshold value (for example, the second user 620 has left the exposure perimeter 635 before the pre-determined amount of time), the post-bid management routine 706 is configured to execute a post-impression reconciliation process. More precisely, since the first digital content item 308 has not been exposed to the second user 620, the post-bid management routine 706 is configured to alter, or change the outcome of the bidding process executed by the bid-determination routine 704. For example, the post-bid management routine 706 may be configured to decrease the highest resultant bidding value.

Indeed, recalling that the first digital content item 308 is associated with a bid of 2 cents for each female over the age of twenty (for a total of 4 cents), the post-bid management routine 706 is configured to decrease the total bidding value of the first digital content item 308 to a total of 2 cents, since only the first user 618 has been exposed to the first digital content item 308.

If on the other hand, it is determined that the likelihood parameter associated with the first user 618, the second user 620 and the third user 634 are above the threshold value (i.e. the first user 618, the second user 620 and the third user 634 have been exposed to the first digital content item 308), but not the likelihood parameter associated with the fourth user 636 is below the threshold value, the post-bid management routine 706 does not alter, or change, the bidding value of the first digital content item 308, and therefore the highest resultant bidding value determined by the bid-determination routine 704 remains unchanged.

Now, although the above explained post-impression reconciliation process has been explained with reference to the first user 618, the second user 620 and the third user 634 from the beginning to the end of the displaying of the first digital content item 308, it is not limited as such. Indeed, it is contemplated that during the displaying of the first digital content item 308, a fourth user 636 passes through the exposure perimeter 635. As such, in some non-limiting embodiments of the present technology, in addition to the signal strengths of the first identifier 628, the second identifier 630 and the third identifier 632 or the signal strengths of the connection (if a connection is established between with the sensor 610) collected during the displaying of the first digital content item 308, the data packet 716 further comprises a fourth identifier 640 collected by the sensor 610 from the fourth electronic device 638. In some non-limiting embodiments of the present technology, the data packet 716 further comprises a second captured image of the exposure perimeter 635 comprising a face of the fourth user 636, captured in response to the sensor 610 detecting the fourth identifier 640.

The post-bid management routine 706 is configured to determine a user aggregated profile associated with the fourth user 636 using the manner described above, and is further configured to determine the likelihood parameter of the fourth user 636 being exposed to the first digital content item 308.

If for example the fourth user 636 is a female over the age of twenty and the likelihood parameter is above the threshold value, the post-bid management routine 706 is configured to execute the post-impression reconciliation process. More precisely, since the first digital content item 308 has been exposed to the fourth user 636 (who was not taken into consideration by during the impression bid), the post-bid management routine 706 is configured to alter, or change the outcome of the bidding process executed by the bid-determination routine 704. For example, the post-bid management routine 706 may be configured to increase the highest resultant bidding value.

Indeed, recalling that the first digital content item 308 is associated with a bid of 2 cents for each female over the age of twenty (for a total of 4 cents), the post-bid management routine 706 is configured to increase the total bidding value of the first digital content item 308 to a total of 6 cents.

The above described selection of digital content item is repeated over a period of time for different users, and the selection application 124 is configured to store an indication of which user has been exposed to which content item. In some non-limiting embodiments, the target parameters associated with each of the plurality of digital content items may comprise a limit on how much a given user is to be exposed to the given digital content item. For example, the first digital content item 308 may be exposed to a given number of times per day (such as twice per day). As such, if it is determined that the first user 618 has been exposed to the first digital content item 308 more than twice in a day, the post-bid management routine 706 is configured to decrease the bidding value of the first digital content item 308 to a total of 2 cents, since the first user 618 is above the number of limits associated with the exposing of the first digital content item 308.

Although in the above described technology, the selection of digital content item is based on target parameters associated with users, it is not limited as such. In some non-limiting embodiments of the present technology, the selection of digital content item is based on target parameters associated with non-user features. For example, the digital content item may be targeted for certain real-time weather conditions (rain, snow, etc.). Needless to say, in these non-limiting embodiments, there would be no need for the determination of the aggregated user profiles and/or facial features when executing the impression bid and the post-impression reconciliation process.

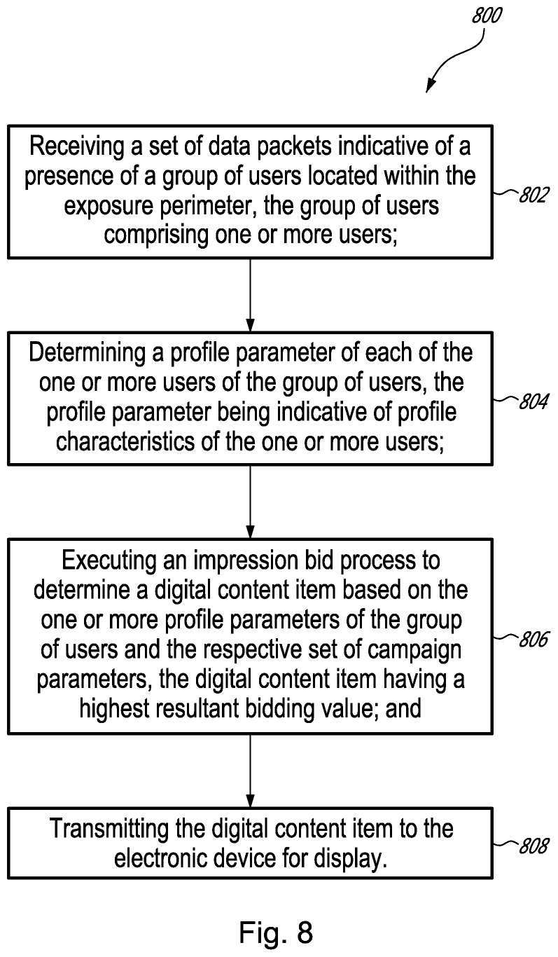

Given the architecture and examples provided hereinabove, it is possible to execute a computer-implemented method for providing a recommended content item. With reference to FIG. 8, there is depicted a flow chart of a method 800 for providing the recommended content item. The method 800 being executable in accordance with non-limiting embodiments of the present technology. The method 800 can be executed by the server 118.

Step 802: Receiving a Set of Data Packets Indicative of a Presence of a Group of Users Located within the Exposure Perimeter, the Group of Users Comprising One or More Users

The method 800 will be explained below with reference to two scenarios. It should be understood that the scenario presented herein below are for illustration purposes only, and the present technology is no way to be limited based on the scenarios presented below.

Scenario 1:

The receiving routine 702 is configured to receive a data packet 708 from one or more electronic devices. For example, the data packet 708 comprises the navigation log for each of the one or more electronic devices nearby the content display device 502. Let us assume that the data packet 708 comprises the navigation logs received from the electronic device 102 (i.e. the navigation log 110), and the electronic device 514, both determined to be within the predetermined distance.

The receiving routine 702 is then configured to build a user navigation status associated with each of the electronic device 102 and the electronic device 514, which is indicative of the respective real-time user movement. For example, based on the navigation log 110, the user navigation status may be indicative that the user associated with the electronic device 102 is travelling on the road 504 towards the content display device 502.

In some non-limiting embodiments of the present technology, the receiving routine 702 is further configured to receive a data packet 710 from the content display device 502. The data packet 710 comprises an indication of the exposure perimeter 510 associated with the content display device 502.

Based on the exposure perimeter 510 and the user navigation status associated with the electronic device 102 and the electronic device 514, the receiving routine 702 is configured to determine whether the electronic device 102 and/or the electronic device 514 is within the exposure perimeter 510 or, is configured to determine an entry likelihood parameter indicative of the electronic device 102 and/or the electronic device 514 entering the exposure perimeter 510 within a predetermined period of time.

The receiving routine 702 is further configured to compare the entry likelihood parameter against the threshold value.

Scenario 2:

The receiving routine 702 is configured to receive a data packet 708 from one or more electronic devices. For example, the data packet 708 comprises the navigation log for each of the one or more electronic devices nearby the content display device 602. In some non-limiting embodiments, the navigation application 108 pre-stores the location of the content display device 602, and is configured to transmit the navigation log 110 to the receiving routine 702 in response to arriving at a predetermined distance from the content display device 502. How the predetermined distance is determined is not limited, and may for example be 10 meters, 20 meters from the location of the content display device 502, and so on.

Let us assume that the data packet 708 comprises the navigation logs received from the first electronic device 622, the second electronic device 624 and the third electronic device 626, all determined to be near the content display device 602. Needless to say, it is contemplated that more or less electronic devices be within the predetermined distance.

The receiving routine 702 is then configured to build a user navigation status associated with each of the first electronic device 622, the second electronic device 624 and the third electronic device 626, which is indicative of the respective real-time user movement.

In some non-limiting embodiments of the present technology, the data packet 708 further comprises an indication of the IP address assigned by the sensor 610 to the first electronic device 622, the second electronic device 624 and the third electronic device 626. As such, the receiving routine 702 is configured to augment the user navigation history by correlating the signal strengths collected by the sensor 610 and the GPS positions of the first electronic device 622, the second electronic device 624 and the third electronic device 626.

Step 804: Determining a Profile Parameter of Each of the One or More Users of the Group of Users, the Profile Parameter being Indicative of Profile Characteristics of the One or More Users

Scenario 1:

In response to the determination that the electronic device 102 and the electronic device 514 are within the exposure perimeter 510 or the respective entry likelihood parameters being above the threshold value, the receiving routine 702 is configured to transmit a data packet 712 to the bid-determination routine 704. The data packet 712 comprises an indication of the user device ID 206 associated with the electronic device 102 (which is retrieved from the navigation log 110 received by the receiving routine 702) and the a user device ID (not shown) associated with the electronic device 514 (which is also retrieved from the navigation log (not shown) received by the receiving routine 702).

The bid-determination routine 704 is configured to access the user profile database 128 and retrieve the respective aggregated based on the user device IDs included within the data packet 712. Let us assume for example, that based that the first aggregated user profile 414 is associated with the electronic device 102, and the second aggregated user profile 417 is associated with the electronic device 514.

Scenario 2:

The receiving routine 702 is configured to transmit a data packet 712 to the bid-determination routine 704. The data packet 712 comprises the information contained within the data packet 708 and data packet 710.

Let us assume, for the purpose of explanation, that the first user 618, the second user 620 and the third user 634 are determined to be within the exposure perimeter 635, either because their associated devices (the first electronic device 622, the second electronic device 624 ad the third electronic device 626) are connected with the sensor 610 and have signals above the predetermined strength, or because the their faces are captured by the first captured image.

Now, based on the data packet 712, the bid-determination routine 704 is configured to (i) determine user profiles associated with each of the first user 618, the second user 620 and the third user 634, and (ii) associated the first electronic device 622, the second electronic device 624 and the third electronic device 626 with their respective users (i.e. the first user 618, the second user 620 and the third user 634).

In some non-limiting embodiments, the bid-determination routine 704 is configured to access the user profile database 128 and determine, based on the user device IDs contained within the navigation logs, that the first user 618 is associated with the first aggregated user profile 414, the second user 620 is associated with the second aggregated user profile 417, and the third user 634 is associated with the third aggregated user profile 418.

Moreover, recalling that the navigation application 108 of the electronic devices have transmitted the bid-determination routine 704 the unique IP address and the user device ID, the bid-determination routine 704 is further configured to associate the unique IP address assigned to each of the electronic devices to their respective associated list of associated unique IDs 416 (see FIG. 4). As such, it is determined that the first electronic device 622 is associated with the first user 618, the second electronic device 624 is associated with the second user 620, and the third electronic device 626 is associated with the third user 634.

Step 806: Executing an Impression Bid Process to Determine a Digital Content Item Based on the One or More Profile Parameters of the Group of Users and the Respective Set of Campaign Parameters, the Digital Content Item Having a Highest Resultant Bidding Value

Scenario 1:

Once the first aggregated user profile 414 and the second aggregated user profile 417 have been retrieved, the bid-determination routine 704 is configured to execute an impression bid process based on the first aggregated user profile 414 and the second aggregated user profile 417. More particularly, the bid-determination routine 704 is configured to access the digital content item database 126 and determine which of the one or more content items is to be displayed on the content display device 502 via the impression bid process.

How the impression bid process is implemented is not limited and may for example be a real-time bidding process. Suffice to say that based on the first aggregated user profile 414 and the target parameters associated with each content item, the bid-determination routine 704 is configured to determine a digital content item having a highest resultant bidding value.

Let us assume, for the purpose of the example, that the digital content item with the highest resultant bidding value corresponds to the first digital content item 308.

Scenario 2:

Based on the determined aggregated user profiles, the bid-determination routine 704 is configured to execute an impression bid process. More particularly, the bid-determination routine 704 is configured to access the digital content item database 126 and determine which of the one or more content items is to be displayed on the content display device 602 via the impression bid process.

For example, let us assume that based on their respective aggregated user profiles, the first user 618 is determined to be a female in her mid-twenties, the second user 620 is determined to be a female in her fifties and the third user 634 is determined to be a male in his thirties. Based on this information, the bid-determination routine 704 is configured to execute the impression bid process (such as a real-time bidding process), in which the bid-determination routine 704 is configured to determine a highest digital content item having a highest resultant bidding value based on the target parameters associated with each content item.

Let us assume, for the purpose of the example, that the digital content item with the highest resultant bidding value corresponds to the first digital content item 308.

Step 808: Transmitting the Digital Content Item to the Electronic Device for Display

Scenarios 1 & 2:

Having determined the first digital content item 308 to be associated with the highest resultant bidding value, the bid-determination routine 704 is configured to transmit the data packet 714 to the content display device 502. The data packet 714 comprises the first digital content item 308 to be displayed on the display screen 508.

In some non-limiting embodiments, the data packet 714 further comprises display instructions, such as the duration and time at which the digital content item 308 must be displayed.

It should be apparent to those skilled in the art that at least some embodiments of the present technology aim to expand a range of technical solutions for addressing a particular technical problem encountered by the conventional content item recommendation services, namely determining the content item based on the one or more users provided in the exposure perimeter.

It should be expressly understood that not all technical effects mentioned herein need to be enjoyed in each and every embodiment of the present technology. For example, embodiments of the present technology may be implemented without the user enjoying some of these technical effects, while other embodiments may be implemented with the user enjoying other technical effects or none at all.

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

While the above-described implementations have been described and shown with reference to particular steps performed in a particular order, it will be understood that these steps may be combined, sub-divided, or reordered without departing from the teachings of the present technology. Accordingly, the order and grouping of the steps is not a limitation of the present technology.

1. A computer-implemented method for providing a digital content item to an electronic device having a display screen with an exposure perimeter, the method being executed by a server coupled to:
a content item database hosting a plurality of digital content items, each of the digital content items of the plurality of digital content items being associated with a respective set of campaign parameters indicative of target profile parameters of a target audience;
the method comprising:
receiving a set of data packets indicative of a presence of a group of users located within the exposure perimeter, the group of users comprising one or more users;
determining a profile parameter of each of the one or more users of the group of users, the profile parameter being indicative of profile characteristics of the one or more users;
executing an impression bid process to determine a digital content item based on the one or more profile parameters of the group of users and the respective set of campaign parameters, the digital content item having a highest resultant bidding value; and
transmitting the digital content item to the electronic device for display.

2. The method of claim 1, wherein
the set of data packets is a first set of data packets;
the group of users is a first group of users;
the digital content item is a first digital content item; and wherein
the method further comprises:
receiving a second set of data packets after a predetermined time period following transmission of the first digital content item to the electronic device for display, the second set of data packets being indicative of a second group of users located within the exposure perimeter, the second group of users comprising one or more users;
determining the profile parameter of each of the one or more users of the second group of users;
executing the impression bid process to determine a second digital content item based on the one or more profile parameters of the group of users and the respective set of campaign parameters, the second digital content item having a highest resultant bidding value; and
transmitting the second digital content item to the electronic device for display.

3. The method of claim 1, wherein
the electronic device comprises a camera configured to capture an image of the exposure perimeter; and
the set of data packets comprises a captured image of the one or more users located within the exposure perimeter.

4. The method of claim 3, wherein determining a profile parameter to each of the one or more users of the group of users comprises analyzing the captured image of the one or more users.

5. The method of claim 4, wherein
the server is further coupled to an online user profile database maintaining one or more user profiles of the one or more users; and wherein
analyzing the captured image of the one or more users comprises correlating the captured image to the one or more user profiles.

6. The method of claim 5, wherein
the one or more users is associated with a respective portable electronic device;
the electronic device is further coupled to one or more sensors configured to exchange signals with the respective portable electronic device of the one or more users; and wherein
the set of data packets further comprises one or more signals of the portable electronic device detected by the sensor, each of the one or more signals comprising at least one of: a signal strength, a period of detection, and a unique identifier.

7. The method of claim 6, wherein
the set of data packets is a first set of data packets;
the captured image is a first captured image;
the group of users is a first group of users;
the method further comprises:
receiving a second set of data packets indicative of a presence of a second group of users located within the exposure perimeter during a time period associated with the display of the digital content item, the second set of data packets comprising at least one of:
a second captured image of the one or more users of the second group of users;
one or more signals of the portable electronic devices associated with the one or more users of the second group of users;
determining the profile parameter to each of the one or more users of the second group of users based on the second set of data packets;
determining a profile parameter variation value based on the variations of the profile parameter to each of the one or more users of the first group of users to the profile parameter to each of the one or more users of the second group of users;
rectifying the highest bidding value based at least on the profile parameter variation value.

8. The method of claim 7, wherein determining the profile parameter to each of the one or more users of the second group of users based on the second set of data packets comprises determining a likelihood parameter indicative of the one or more users having been exposed to the first digital content item based on the one or more signals.

9. The method of claim 8, wherein
the one or more users of the second group of users correspond to the one or more users of the first group of users; and
the first set of data packet comprises a smaller set of information associated with the one or more users, and the second set of data packet comprises a larger set of information associated with the one or more users.

10. The method of claim 7, wherein rectifying the highest bidding value comprises one of increasing the highest bidding value and lowering the highest bidding value.

11. The method of claim 1, wherein the profile characteristics of a given user include at least one of:
an estimated range of age of the given user;
a gender of the given user;
an estimated time of the given user being located within the exposure perimeter.

12. The method of claim 1, wherein the electronic device is a user-independent electronic device.

13. The method of claim 12, wherein the user-independent electronic device is located in one of an indoor and an outdoor location.

14. The method of claim 1, wherein
the electronic device is an outdoor user-independent device;
the one or more users is associated with a respective portable electronic device, each of the electronic device having a geo-sensor; and wherein
receiving the set of data packets comprises receiving data having been captured by the geo-sensor.

15. The method of claim 14, wherein the method further comprises analyzing the data packets to generate a geo-track information associated with the electronic device.

16. The method of claim 15, wherein the geo-track information is used for the impression bid process.

17. The method of claim 15, further comprising using the geo-track information for executing a post-impression exposure reconciliation process.

18. A system for providing a digital content item to an electronic device having a display screen with an exposure perimeter, the system comprising a server connectable to:
a content item database hosting a plurality of digital content items, each of the digital content items of the plurality of digital content items being associated with a respective set of campaign parameters indicative of target profile parameters of a target audience;
the server comprising a processor configured to:
receive a set of data packets indicative of a presence of a group of users located within the exposure perimeter, the group of users comprising one or more users;
determine a profile parameter of each of the one or more users of the group of users, the profile parameter being indicative of profile characteristics of the one or more users;
execute an impression bid process to determine a digital content item based on the one or more profile parameters of the group of users and the respective set of campaign parameters, the digital content item having a highest resultant bidding value; and
transmit the digital content item to the electronic device for display.

19. The system of claim 18, wherein
the set of data packets is a first set of data packets;
the captured image is a first captured image;
the group of users is a first group of users; and
the processor is further configured to:
receive a second set of data packets indicative of a presence of a second group of users located within the exposure perimeter during a time period associated with the display of the digital content item, the second set of data packets comprising at least one of:
a second captured image of the one or more users of the second group of users;
one or more signals of the portable electronic devices associated with the one or more users of the second group of users;
determine the profile parameter to each of the one or more users of the second group of users based on the second set of data packets;
determine a profile parameter variation value based on the variations of the profile parameter to each of the one or more users of the first group of users to the profile parameter to each of the one or more users of the second group of users;
rectify the highest bidding value based at least on the profile parameter variation value.

20. The system of claim 19, wherein to determine the profile parameter to each of the one or more users of the second group of users based on the second set of data packets, the processor is configured to determine a likelihood parameter indicative of the one or more users having been exposed to the first digital content item based on the one or more signals.
